(19) United States
(12) Patent Application Publication
(10) Pub. No.: US 2018/0085617 A1
(43) Pub. Date: Mar. 29, 2018

(54) STATIONARY BICYCLE

(71) Applicant: Ben Adom, Yucaipa, CA (US)

(72) Inventor: Ben Adom, Yucaipa, CA (US)

(21) Appl. No.: 15/713,674

(22) Filed: Sep. 24, 2017

Related U.S. Application Data
(60) Provisional application No. 62/401,758, filed on Sep. 29, 2016.

(51) Int. Cl. A63B 21/00; A63B 22/06; A63B 24/00; A63B 23/04; A61H 1/02

(52) U.S. Cl. CPC A63B 21/00181; A61H 2201/1642; A63B 24/0087; A63B 21/4034; A63B 21/4049; A63B 23/0476; A61H 1/0237; A61H 1/0214; A63B 2225/093; A63B 2209/00; A63B 2208/0233; A61H 2201/0192; A61H 2201/1215; A61H 2201/1463; A61H 2201/1671; A63B 22/0605

(57) ABSTRACT

The improved stationary bicycle is a self powered exercise bicycle that may, in addition to building strength with the type of resistance exercise that is typically done with standard exercise bicycles, may be used to move the muscles of an individual that is too feeble to rotate the pedals on their own through a full range of motion using the self powered function. A brake lever on one of the handles of the handle bars may be used to stop the pedals from rotating. A programming function allows the user to select various user preferred speeds.

### CROSS-REFERENCE TO RELATED APPLICATION

The present application is related to and claims priority from prior provisional application Ser. No. 62/401,758, filed Sep. 29, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of stationary exercise bicycles and more specifically relates to an improved stationary bicycle.

### 2. Description of the Related Art

Stationary bicycles are exercise bicycles having a seat, pedals, and some form of handlebars arranged similar to a bicycle. Commonly, exercise bicycles provide a mechanism for applying resistance to the pedals that is able to increase the intensity of the exercise by increasing the resistance as the user pedals. Resistance mechanisms are often created by magnets, fans, and friction mechanisms. These devices are able to develop mass, strength, and endurance, in the muscles that they mobilize during the workout and are found in nearly every gym. The advantage in stationary bicycles is the variable resistance. They can benefit a wide range of people of different fitness levels. Older persons and people in rehabilitation may not be able to successfully use a conventional stationary bicycle though. Any amount of resistance may be too much for some people. A solution to benefit this category of people is needed.

Various attempts have been made to solve the above-mentioned problems such as those found in U.S. Pat. No. 7,833,135 to Radow et al.; U.S. Pat. No. 8,608,622 to Jay L. Alberts; U.S. Pat. No. 7,226,393 to William A. Baker; and U.S. Pat. No. 5,643,146 to Stark et al. This art is representative of stationary bicycles. None of the above inventions and patents, taken either singly or in combination, is seen to describe the invention as claimed.

Ideally, a stationary bicycle should provide variable resistance as well as variable speed self powered motion, and yet, would operate reliably and be manufactured at a modest expense. Thus, a need exists for a reliable improved stationary bicycle to avoid the above-mentioned problems.

### BRIEF SUMMARY OF THE INVENTION

In view of the foregoing disadvantages inherent in the known stationary exercise bicycle art, the present invention provides a novel improved stationary bicycle. The general purpose of the present invention, which will be described subsequently in greater detail, is to provide variable resistance as well as variable speed self powered motion.

The improved stationary bicycle preferably comprises a main frame having an extended portion located on an upper section and adapted to secure an adjustable seat thereto, at least one adjustable floor stand located on a lower section and adapted to hold the main frame in a chosen orientation relative to the supporting surface, an adjustable seat removably and adjustably attached to the extended portion, a handle member removably and adjustably attached to the upper section of the main frame, a pedaling apparatus including two pedal arms located on opposite sides of the main frame, two pedal members respectively attach to distal end portions of each of the two pedal arms, a pedal axle attached between respective proximal end portions of each of the two pedal arms, and rotatably attached to the main frame at a middle section thereof, a pedaling assist member attached to the main frame and mechanically connected to the pedaling apparatus and is adapted to assist a user in rotating the pedaling apparatus, and a power source. The power source is attached to the main frame and electrically connected to the pedaling assist member, and adapted to provide electric power to the pedaling assist member.

The adjustable floor stand comprises four adjustable floor stands attached to a bottom portion of the main frame and each one is adapted to hold the main frame in a chosen position relative to a supporting surface. The adjustable seat includes a seat cushion, a seat tube, and a height adjustment member. The height adjustment member includes a clamping member adapted to hold the height adjustment member at a chosen position with respect to the extended portion of the main frame. The height adjustment member includes a pin member adapted to hold the height adjustment member at a chosen position with respect to the extended portion of the main frame.

The pedaling assist member includes an electric motor connected to the main frame, an axle member adapted to be rotated by the electric motor, a first wheel member connected to the pedaling assist member and the axle member and adapted to be rotated by the electronic motor, a second wheel member mechanically connected to the pedal axle, and a belt member mechanically connected between the first wheel member and the second wheel member and adapted to be rotated by the electric motor and adapted to rotate the second wheel member and thereby the pedaling apparatus. Each of the two pedal members includes a foot attachment member adapted to releasably hold a user's feet to respective pedal members.

The handle member includes control members thereon adapted to control the electric motor to thereby rotate at variable speeds in order to assist a user to pedal at different rotational speeds, and to stop the rotation of the electric motor such that a user may stop pedaling. The power source is formed as a power cord adapted to be plugged into an electric outlet of an external power source. The main frame has a substantially triangular shape. The extended portion has a substantially tubular shape. The handle member includes hand grip members on opposite ends thereof adapted to be gripped by a user when in use. The handle member further includes a hand brake member in proximity to one of the hand grip members and is adapted to be gripped and squeezed by the user when the user desires to slow down or stop the pedaling apparatus from rotating and is adapted to slow down or stop the rotation of the belt member. The main frame is formed from a material chosen from a group of materials consisting of aluminum, steel, titanium, and ceramic.

The present invention holds significant improvements and serves as an improved stationary bicycle. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, improved stationary bicycle constructed and operative according to the teachings of the present invention.

FIG. 1 shows a side view illustrating an improved stationary bicycle according to an embodiment of the present invention.

FIG. 2 is a rear view illustrating the improved stationary bicycle according to an embodiment of the present invention of FIG. 1.

FIG. 3 is a side view illustrating the major inner components of the improved stationary bicycle according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a stationary exercise bicycle and more particularly to an improved stationary bicycle as used to improve versatility by providing variable resistance as well as variable speed self powered motion.

Generally speaking, the improved stationary bicycle is a self powered exercise bicycle that may, in addition to building strength with the type of resistance exercise that is typically done with standard exercise bicycles, may be used to move the muscles of an individual that is too feeble to rotate the pedals on their own through a full range of motion using the self powered function. A brake lever on one of the handles of the handle bars may be used to stop the pedals from rotating. A programming function allows the user to select various user preferred speeds.

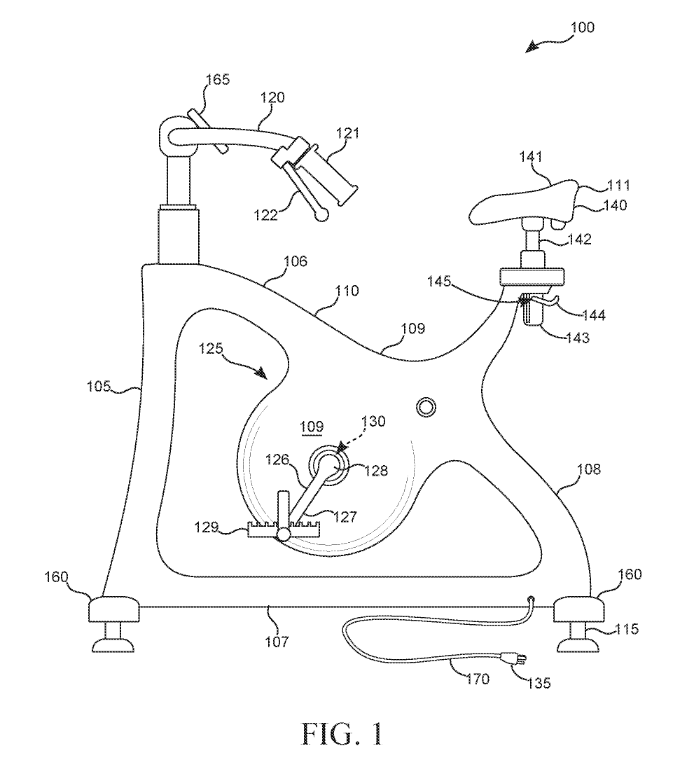

Referring to the drawings by numerals of reference there is shown in FIG. 1, a side view illustrating improved stationary bicycle 100 according to an embodiment of the present invention.

Improved stationary bicycle 100 preferably comprises main frame 105 having extended portion 110, located on upper section 106 and adapted to secure adjustable seat 111 thereto, at least one adjustable floor stand 115 located on lower section 108 and adapted to hold main frame 105 in a chosen orientation relative to the supporting surface, adjustable seat 111 removably and adjustably attached to extended portion 110, handle member 120 removably and adjustably attached to upper section 106 of main frame 105, pedaling apparatus 125 including two pedals arms 126 located on opposite sides of main frame 105, two pedal members 129 respectively attach to distal end portions 127 of each of the two pedals arms 126, axle member 130 attached between respective proximal end portions 128 of each of the two pedals arms 126, and rotatably attached to main frame 105 at middle section 109 thereof, pedaling assist member 150 attached to main frame 105 and mechanically connected to pedaling apparatus 125 and is adapted to assist a user in rotating pedaling apparatus 125, and power source 135. Power source 135 is attached to main frame 105 and electrically connected to pedaling assist member 150, and adapted to provide electric power to pedaling assist member 150.

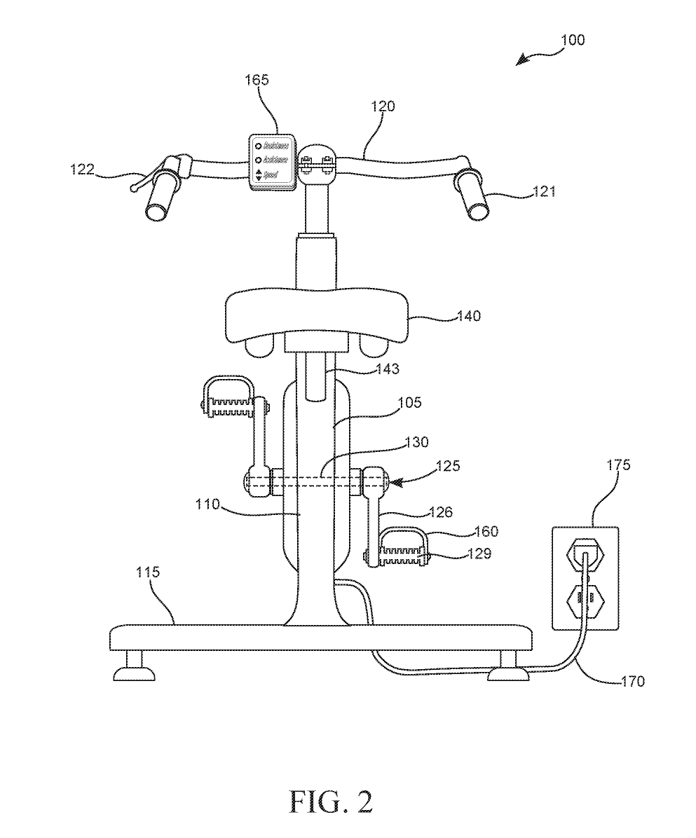

Referring now to FIG. 2, is a rear view illustrating improved stationary bicycle 100 according to an embodiment of the present invention of FIG. 1.

Adjustable floor stand 115 comprises four adjustable floor stands 115 attached to bottom portion 107 of main frame 105 and each one is adapted to hold main frame 105 in a chosen position relative to a supporting surface. Adjustable seat 140 includes seat cushion 141, seat tube 142, and height adjustment member 143. Height adjustment member 143 includes clamping member 144 adapted to hold height adjustment member 143 at a chosen position with respect to extended portion 110 of main frame 105. Height adjustment member 143 includes pin member 145 adapted to hold height adjustment member 143 at a chosen position with respect to extended portion 110 of main frame 105.

Pedaling assist member 150 includes electric motor 151 connected to main frame 105, axle member 130 adapted to be rotated by electric motor 151, first wheel member 152 connected to pedaling assist member 150 and axle member 130 and adapted to be rotated by electric motor 151, second wheel member 153 mechanically connected to axle member 130, and belt member 154 mechanically connected between first wheel member 152 and second wheel member 153 and adapted to be rotated by electric motor 151 and adapted to rotate second wheel member 153 and thereby pedaling apparatus 125. Each of the two pedal members 129 includes foot attachment member 160 adapted to releasably hold a user's feet to respective pedal members 129.

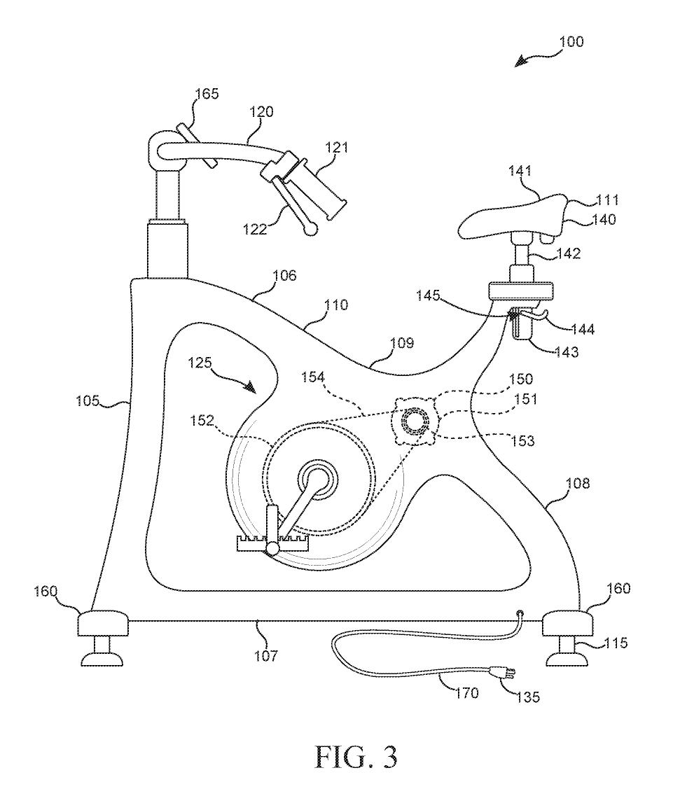

Referring now to FIG. 3, is a side view illustrating the major inner components of improved stationary bicycle 100 according to an embodiment of the present invention of FIG. 1.

Handle member 120 includes control members 165 thereon adapted to control electric motor 151 to thereby rotate at variable speeds in order to assist a user to pedal at different rotational speeds, and to stop the rotation of electric motor 151 such that a user may stop pedaling. Power source 135 is formed as power cord 170 adapted to be plugged into electric outlet 175 of an external power source 135. Main frame 105 has a substantially triangular shape. Extended portion 110 has a substantially tubular shape. Handle member 120 includes hand grip members 121 on opposite ends thereof adapted to be gripped by a user when in use. Handle member 120 further includes hand brake member 122 in proximity to one of hand grip members 121 and is adapted to be gripped and squeezed by the user when the user desires to slow down or stop the pedaling apparatus from rotating and is adapted to slow down or stop the rotation of belt member 154. Main frame 105 is formed from a material chosen from a group of materials consisting of aluminum, steel, titanium, and ceramic.

Improved stationary bicycle 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An improved stationary bicycle comprising:
a main frame including:
an extended portion;
wherein said extended portion is located on an upper section thereof and adapted to secure an adjustable seat thereto; and
at least one adjustable floor stand;
wherein said at least one adjustable floor stand is located on a lower section thereof and adapted to hold said main frame in a chosen orientation relative to a supporting surface;
an adjustable seat;
wherein said adjustable seat is removably and adjustably attached to said extended portion;
a handle member;
wherein said handle member is removably and adjustably attached to an upper section of said main frame;
a pedaling apparatus including:
two pedals arms located on opposite sides of said main frame;
two pedal members respectively attach to distal end portions of each of said two pedal arms;
a pedal axle attached between respective proximal end portions of each of said two pedal arms, and rotatably attached to said main frame at a middle section thereof;
a pedaling assist member;
wherein said pedaling assist member is attached to said main frame and mechanically connected to said pedaling apparatus; and
wherein said pedaling assist member is adapted to assist a user in rotating said pedaling apparatus; and
a power source;
wherein said power source is attached to said main frame and electrically connected to said pedaling assist member, and adapted to provide electric power to said pedaling assist member.

2. The improved stationary bicycle of claim 1, wherein said at least one adjustable floor stand comprises four adjustable floor stands attached to a bottom portions of said main frame each adapted to hold said main frame in a chosen position relative to a supporting surface.

3. The improved stationary bicycle of claim 1, wherein said adjustable seat includes a seat cushion, a seat tube, and a height adjustment member.

4. The improved stationary bicycle of claim 3, wherein said height adjustment member includes a clamping member adapted to hold said height adjustment member at a chosen position with respect to said extended portion of said main frame.

5. The improved stationary bicycle of claim 3, wherein said height adjustment member includes a pin member adapted to hold said height adjustment member at a chosen position with respect to said extended portion of said main frame.

6. The improved stationary bicycle of claim 1, wherein said pedaling assist member includes an electric motor connected to said main frame; an axle member adapted to be rotated by said electric motor; a first wheel member connected to said pedaling assist member axle member and adapted to be rotated by said electronic motor; a second wheel member mechanically connected to said pedal axle; and a belt member mechanically connected between said first wheel member and said second wheel member and adapted to be rotated by said electric motor, and adapted to rotate said second wheel member and thereby said pedaling apparatus.

7. The improved stationary bicycle of claim 1, wherein each of said two pedal members includes a foot attachment member adapted to releasably hold a user's feet to respective said two pedal members.

8. The improved stationary bicycle of claim 6, wherein said handle member includes control members thereon adapted to control said electric motor to thereby rotate at variable speeds in order to assist a user to pedal at different rotational speeds, and to stop the rotation of said electric motor such that a user may stop pedaling.

9. The improved stationary bicycle of claim 1, wherein said power source is formed as a power cord adapted to be plugged into an electric outlet of an external power source.

10. The improved stationary bicycle of claim 1, wherein said main frame has a substantially triangular shape.

11. The improved stationary bicycle of claim 1, wherein said extended portion has a substantially tubular shape.

12. The improved stationary bicycle of claim 1, wherein said handle member includes hand grip members on opposite ends thereof adapted to be gripped by a user when in use.

13. The improved stationary bicycle of claim 12, wherein said handle member further includes a hand brake member in proximity to one of said hand grip members and is adapted to be gripped and squeezed by a user when said user desires to slow down or stop said pedaling apparatus from rotating.

14. The improved stationary bicycle of claim 6, wherein said handle member includes a hand brake member adapted to slow down or stop the rotation of said belt member.

15. The improved stationary bicycle of claim 1, wherein said main frame is formed from a material chosen from a group of materials consisting of aluminum, steel, titanium, and ceramic.
